(19) United States
(12) Patent Application Publication
(10) Pub. No.: US 2026/0097657 A1
(43) Pub. Date: Apr. 9, 2026

(54) ROBOT COMPANION DEVICE FOR ADJUSTING MOTOR BEHAVIOUR ACROSS DIFFERENT SURFACES AND USAGE PATTERNS OF MOTOR

(71) Applicant: RN CHIDAKASHI TECHNOLOGIES PRIVATE LIMITED, Mumbai (IN)

(72) Inventors: Kushal Jagdish Kirpalani Idnani, Mumbai (IN); Simit Pradhan, Hyderabad (IN)

(21) Appl. No.: 19/352,811

(22) Filed: Oct. 8, 2025

(30) Foreign Application Priority Data
Oct. 8, 2024 (IN) 202421075983

(51) Int. Cl. B60L 3/00; A63H 11/00; A63H 29/22; B60L 15/20; H02P 23/00; H02P 23/14

(52) U.S. Cl. CPC B60L 3/0061; A63H 11/00; A63H 29/22; B60L 15/20; H02P 23/0018; H02P 23/14; A63H 2200/00; B60L 2240/421; B60L 2240/427

(57) ABSTRACT

A robot companion device 100 that dynamically adjusts a behaviour of a motor 102 across different surfaces and usage patterns of the motor. The robot companion device includes encoders 104A-N that are coupled to the motor that is configured to measure the speed and the velocity of the motor. The robot companion device includes a processor that is configured to (i) generate an interpolated speed and velocity of the motor and operating conditions of the robot companion device in the surfaces, (ii) detect a motor behaviour state, (iii) determine the motor behaviour as an abnormal behaviour state, (iv) increase the threshold motor speed and velocity of the motor to reduce state fluctuations, and (v) dynamically adjust, using the machine learning model, the behaviour of the motor in the surfaces and the usage patterns of the motor in real-time.

### BACKGROUND

### Technical Field

The embodiments herein generally relate to detecting motor usage patterns and motor behaviour, more particularly, a robot companion device that dynamically adjusts a behaviour of a motor across different surfaces and usage patterns of the motor.

### Description of the Related Art

Digital gadgets and devices have become an integral part of everyday human life. Among these, mobile companion devices, such as mobile robots designed for children, are increasingly popular. These devices are lightweight and compact, allowing children to easily carry them around. However, safety is a crucial consideration in their design due to the presence of rapidly moving parts. A significant concern is that these devices contain various electronic components, including motors that operate at high speeds, which can pose risks such as children's body parts getting caught in the moving parts while they handle the device. The risk of injury is particularly high if children's fingers or skin get trapped in the gaps between the wheels of these mobile companion devices.

Existing solutions to this problem include using target sensors such as limit switches or Inertial Measurement Units (IMUs) to detect if a mobile robot has lost contact with a surface. While these systems can provide protection in specific scenarios, such as when the bot is lifted from a surface, they may fail in other situations, such as when the mobile companion device is placed on a child's lap.

Another concern is the safety of the actuators in mobile companion devices. In cost-optimized devices, it is challenging to include an array of sensors to monitor actuator operations. Under these circumstances, ensuring that the actuators always operate within their designed range is critical to the device's safe functioning.

Therefore, there arises a need to address the aforementioned technical drawbacks in existing technologies and gadgets.

### SUMMARY

In view of the foregoing, an embodiment herein provides a robot companion device that dynamically adjusts a behaviour of a motor across different surfaces and usage patterns of the motor. The robot companion device includes the motor, one or more encoders that are coupled to the motor of the robot companion device. The one or more encoders are configured to measure the speed and the velocity of the motor in real-time when the robot companion device is operated on a plurality of surfaces. The robot companion device further includes a memory that stores one or more instructions and a processor that executes the one or more instructions. The processor is configured to (i) generate (a) an interpolated speed and velocity of the motor for varying operating conditions by mapping the speed of the motor across different voltages supplied to the motor, and (b) a plurality of operating conditions of the robot companion device in the plurality of surfaces, (ii) detect a motor behaviour state by dynamically comparing measured speeds and velocities of the motor with a threshold motor speed and velocity using a detection algorithm, (iii) determine the motor behaviour as an abnormal behaviour state and automatically trigger a stop condition of the motor when the measured speed and velocity of the motor falls below the threshold motor speed and velocity, (iv) increase the threshold motor speed and velocity of the motor to reduce state fluctuations by implementing a debouncing technique that analyzes a duration of the abnormal motor behaviour state confirming the abnormality; and (v) dynamically adjust, using the machine learning model, the behaviour of the motor in the plurality of surfaces and the usage patterns of the motor in real-time by dynamically recalibrating the threshold motor speed and velocity of the motor based on the motor usage patterns and aging by continuously updating the threshold motor speed and velocity of the motor.

In some embodiments, the machine learning model determines normal behaviour and triggers a continuation condition of the motor when the measured speed and velocity of the motor is above the threshold motor speed and velocity.

In some embodiments, the machine learning model is trained to determine a threshold motor speed and velocity of the motor at different stages of the motor behaviour state and dynamically adjusts the threshold motor speed and velocity of the motor on different surfaces and usage patterns.

In some embodiments, the threshold motor speed and velocity of the mobile companion device is a predefined speed limit that serves as a benchmark for normal operation of the mobile companion device's motors.

In some embodiments, the processor is configured to divide the operating voltage range supplied to the mobile companion device into equally spaced defined voltages.

In some embodiments, the processor is configured to run the motor at the specific defined voltages to measure the motor speed of the mobile companion device when freewheeling to obtain a freewheeling speed.

In some embodiments, the threshold motor speed, below which the motor velocity is deemed abnormal, is determined by multiplying the freewheeling motor speed by a minimum percentage value, wherein the percentage value is established after running numerous test cases to find a value that minimizes false positives while effectively and quickly detecting abnormal conditions.

In some embodiments, the processor is configured to determine the confirmation time period by running experiment with different time values and identifying a value that has minimum false stall.

In some embodiments, the processor is configured to enable a normal operating condition to revert if the motor speed of the mobile companion device exceeds the increased threshold motor speed with the confirmation time period to avoid false positives.

In some embodiments, the processor is configured to update the threshold motor speed during runtime by implementing an online calibration workflow that updates a voltage-to-motor velocity map during free-wheeling conditions of the mobile companion device and storing the updated voltage-to-motor velocity map in non-erasable system memory.

In some embodiments, the processor is configured to trigger recalibration of the threshold motor speed for aging motors of the mobile companion device based on a frequency of false stall detections during a predefined movement and notify a user when the calibration is out of date to ensure current calibration curves stay updated even during aging.

In some embodiments, a method to dynamically adjust a behaviour of a motor across different surfaces and usage patterns of the motor in a robot companion device is provided. The method includes (i) measuring the speed and the velocity of the motor in real-time when the robot companion device is operated on a plurality of surfaces using one or more encoders that are coupled to the motor of the robot companion device, (ii) generating (a) an interpolated speed and velocity of the motor for varying operating conditions by mapping the speed of the motor across different voltages supplied to the motor, and (b) a plurality of operating conditions of the robot companion device in the plurality of surfaces, (iii) detecting a motor behaviour state by dynamically comparing measured speeds and velocities of the motor with a threshold motor speed and velocity using a detection algorithm, (iv) determining the motor behaviour as an abnormal behaviour state and automatically trigger a stop condition of the motor when the measured speed and velocity of the motor falls below the threshold speed and velocity, (v) increasing the threshold motor speed and velocity of the motor to reduce state fluctuations by implementing a debouncing technique that analyzes a duration of the abnormal motor behaviour state confirming the abnormality, and (vi) dynamically adjusting, using the machine learning model, the behaviour of the motor in the plurality of surfaces and the usage patterns of the motor in real-time by dynamically recalibrating the threshold motor speed and velocity of the motor based on the motor usage patterns and aging by continuously updating the threshold motor speed and velocity of the motor.

The robot companion device enables an adaptive motor threshold calibration using machine learning model by monitoring and logging the motor speed of the mobile companion device and the motor usage over time. The machine learning model is trained to predict an appropriate threshold motor speed at different stages of the motor usage and dynamically adjusts the threshold motor speed to determine the motor behaviour on different surfaces and usage conditions. The robot companion device ensures an up-to-date calibration by monitoring an occurrence of false stall detection during the movements of the mobile companion device and sending the notifications to the user when a frequency of false detections exceeds a threshold value, indicating the need for recalibration. The robot companion device monitors the motor speed, detects abnormalities, and adapts to motor wear ensures robust and safe operation of the mobile companion device, particularly in the context of user's/children's companion robots. The robot companion device safeguards users against harm due to wheel-pinching while interacting. The robot companion device further safeguards drive-system components against intentional/unintentional stalling of the wheels. The robot companion device may run on different surfaces with varying friction like carpets, smooth flooring, etc. without falsely triggering wheel stall detection. The robot companion device provides improvement in motors life-cycle by early detection of ageing and recalibration of control parameters.

### BRIEF DESCRIPTION OF THE DRAWINGS

The embodiments herein will be better understood from the following detailed description with reference to the drawings, in which:

FIG. 1 illustrates a robot companion device that dynamically adjusts a behaviour of a motor across different surfaces and usage patterns of the motor according to some embodiments herein;

FIG. 2 illustrates an exploded view of the robot companion device of FIG. 1 according to some embodiments herein;

FIGS. 3A-3B illustrates recalibration of robot companion device in case of two events that is End-of-line calibration and Aging calibration according to some embodiments herein;

FIGS. 4A-4B illustrates a method for dynamically adjusting a behaviour of a motor across different surfaces and usage patterns of the motor in the robot companion device according to some embodiments herein; and

FIG. 5 is a schematic diagram of a system in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

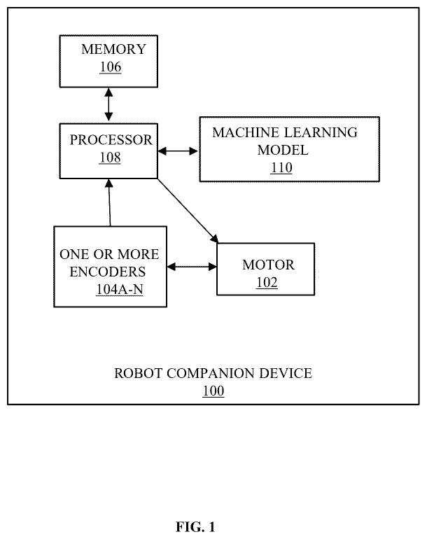

As mentioned, there remains a need for mitigating and/or overcoming drawbacks associated with existing systems or gadgets or robot companion devices. Referring now to the drawings, and more particularly to FIGS. 1 through 5, where similar reference characters denote corresponding features consistently throughout the figures, preferred embodiments are shown.

FIG. 1 illustrates a robot companion device 100 that dynamically adjusts a behaviour of a motor across different surfaces and usage patterns of the motor according to some embodiments herein. The robot companion device 100 includes a motor 102 and one or more encoders 104A-N that measures the speed and the velocity of the motor 102 in real-time when the robot companion device 100 is operated on a plurality of surfaces. The one or more encoders 104A-N are attached to a motor 102 of the robot companion device 100 to measure the motor speed. The robot companion device 100 includes a processor 108 and a memory 106. The processor 108 is configured to monitor and control motor speed in the robot companion device (e.g., a mobile robot) 100. The robot companion device 100 maps the motor speed with different defined voltages that is supplied to the robot companion device 100 to generate (i) an interpolated speed for intermediate voltages and (ii) one or more operating conditions of the robot companion device 100 in one or more surfaces. For example, the robot companion device 100 divides the operating voltage range supplied to the robot companion device 100 into equally spaced defined voltages. The robot companion device 100 then runs the motor 102 at these specific defined voltages and measures the motor speed of the robot companion device 100 when freewheeling. This speed is considered the freewheeling speed. The threshold motor speed, below which the motor velocity is deemed abnormal, is determined by multiplying the freewheeling motor speed by a minimum percentage value. This percentage value is established after running numerous test cases to find a value that minimizes false positives while effectively and quickly detecting abnormal conditions. The robot companion device 100 may compute the motor speed for voltages other than the defined voltages using a linear interpolation.

The robot companion device 100 detects motor behaviour state by dynamically comparing measured speeds and velocities of the motor with a threshold motor speed and velocity using a detection algorithm. The detection algorithm determines a threshold motor speed below which the motor velocity is deemed abnormal, based on the voltage supplied to the motor 102. If the motor speed measured by the one or more encoders 104A-N falls below this threshold motor speed for a confirmation time period, the robot companion device 100 considers it to be in an abnormal condition. However, instead of immediately shutting off the motor 102, the robot companion device 100 starts a timer. This timer, referred to as the confirmation time period, allows the robot companion device 100 to observe if the abnormal condition persists. If the condition does not change within the confirmation time period, the robot companion device 100 then stops the motor.

If the motor speed/velocity of the robot companion device 100 falls below the threshold motor speed, the robot companion device 100 waits for a confirmation time period (e.g. 1 to 5 milliseconds) to observe any changes in behaviour. If the abnormal condition persists beyond this confirmation time period, the robot companion device 100 stops the motor 102. The threshold motor speed of the robot companion device 100 refers to a predefined speed limit that serves as a benchmark for normal operation of the motor 102. In some embodiment, the confirmation time is set/determined based on extensive testing and experimentation.

The robot companion device 100 employs a debouncing technique that increases the threshold motor speed and velocity of the motor in case of an abnormal condition of the robot companion device 100 to avoid state fluctuations and to confirm the abnormal state of the robot companion device 100 based on the confirmation time period/duration of the abnormal condition (e.g. 1 to 5 milliseconds). The robot companion device 100 may determine the confirmation time period by running experiment with different time value and identifying a value that has minimum false stall but the robot companion device 100 is still effective to detect abnormal condition without the user getting hurt or the motor 102 getting damaged. The debouncing technique may adjust the threshold motor speed to avoid false positives. For example, when the robot companion device 100 first detects an abnormal condition, it raises the threshold motor speed by a percentage known as the hysteresis percentage. This adjustment helps prevent state fluctuation and ensures that the abnormal condition is indeed a true positive. If the condition is genuine, the motor speed will not exceed the increased threshold motor speed, leading to a confident decision to stop the motor 102. In some embodiments, the abnormal condition refers to any condition that may causes the motor 102 to draw higher current that can be considered as an abnormal condition. Although the robot companion device 100 does not directly measure the current drawn by the motor 102, it instead checks the motor speed against a predefined threshold motor speed. This approach allows the robot companion device 100 to identify conditions that may indicate a higher current draw, such as a finger pinch, cloth stuck, hair stuck, or the motors struggling on heavy rugs.

The robot companion device 100 may include a timer to verify the persistence of the abnormal state. If the abnormal state of the robot companion device 100 does not change over the confirmation time period, the robot companion device 100 forces the motor 102 to an off state or continues with normal operation otherwise.

The robot companion device 100 enhances the motor speed control by employing the debouncing technique that increases the threshold motor speed when an abnormal condition of the robot companion device 100 is detected. The robot companion device 100 enables a normal operating condition to revert if the motor speed exceeds the increased threshold motor speed with the confirmation time period, thus avoiding false positives.

The robot companion device 100 employs a machine learning model 110 to recalibrate the threshold motor speed based on the motor usage and aging by monitoring the motor speed and the motor usage of the robot companion device 100 to update the threshold motor speed. The machine learning model 110 may be trained by providing motor velocities at different voltages collected when the robot companion device 100 runs in different surface. This training helps in calibrating threshold motor speed for different surface. The machine learning model 110 may be trained for calibrating threshold motor speed for different usage cycles by being trained with data collected for motor velocities at different voltages for the robot companion device 100 that have been used for different period. The robot companion device 100 detects a motor usage pattern over a motor usage cycle and adjusts the threshold motor speed based on the motor usage pattern to avoid false positives due to motor deterioration. The machine learning model 110 may be trained for calibrating the threshold motor speed for different usage cycles by being trained with data collected for motor velocities at different voltages for the robot companion device 100 that have been used for different period.

The robot companion device 100 may update the calibration data (i.e. the threshold motor speed) during runtime by implementing an online calibration workflow that updates a voltage-to-motor velocity map during free-wheeling conditions of the robot companion device 100 and storing the updated voltage-to-motor velocity map in non-erasable memory 106. The robot companion device 100 may trigger the recalibration of the threshold motor speed for aging motors based on a frequency of false stall detections during a predefined movement and may notify the user when the calibration is out of date to ensure current calibration curves.

The robot companion device 100 may protect the motor 102 by monitoring its motor speed and comparing it to threshold motor speed/expected values to detect resistance or hurdles. The robot companion device 100 may stop the motor if the motor speed/velocity of the mobile companion device 102 falls below the threshold motor speed for a confirmation time period (e.g. 1 to 5 milliseconds) (i.e. when a higher current is drawn due to obstacles that is detected) to prevent the motor deterioration.

The robot companion device 100 further includes one or more sensor units and one or more electronic modules (e.g., mobile or immobile electronic modules). The one or more sensor units includes a weather tracking unit, a global positioning system (GPS) unit, an audio sensor, a pressure sensor, a speaker unit, a temperature sensor, a recorder unit, a visual sensor and/or an identification unit.

In some embodiments, a user is a human interacting with the robot companion device 100. In some embodiments, the robot companion device 100 may be communicatively connected to an input unit including, but not limited to a keyboard, a keypad, a handheld device, a microphone, a remote controller, a console, a Bluetooth operated device or a smart touch screen linked to an electronic device. The input unit may receive an interaction request from the user (e.g., a child). The input unit communicatively transmit the interaction request to the mobile companion device 102 through a network. The network may be, but not limited to, a wireless network, a wired network, a combination of the wired network and the wireless network or Internet and the like.

The robot companion device 100 enables an adaptive motor threshold calibration using machine learning model 110 by monitoring and logging the motor speed and the motor usage over time. The machine learning model 110 is trained to predict an appropriate threshold motor speed at different stages of the motor usage and dynamically adjusts the threshold motor speed to determine the motor behaviour on different surfaces and usage conditions. The robot companion device 100 ensures an up-to-date calibration by monitoring an occurrence of false stall detection during the movements of the robot companion device 100 and sending the notifications to the user when a frequency of false detections exceeds a threshold value, indicating the need for recalibration. The robot companion device 100 that monitors the motor speed, detects abnormalities, and adapts to motor wear ensures robust and safe operation, particularly in the context of user's/children's companion robots.

As the user/children's toy, the robot companion device 100 may frequently interact with users. During these interactions, there is a risk of body parts or clothing accessories of the user getting caught in the gap between the motor 102 and the plastic of the robot companion device 100. The robot companion device 100 may help to prevent injuries and damage to the user's property. When the motor 102 of the mobile companion device 102 is not running at the expected velocity/threshold motor speed, due to some hindrance, the robot companion device 100 may cause the motor 102 to draw higher current and cause damage to the windings of the motor. In such scenarios, the robot companion device 100 may protect the motor 102 from damage. The robot companion device 100 that monitors the motor velocity against expected behaviour may detect scenarios where the robot companion device 100 struggles to move, causing it to draw higher current and drain the battery faster. By avoiding such scenarios, the battery usage of the robot companion device 100 is optimized, thus increasing the run-time. As the user/children's toy, the robot companion device 100 is expected to endure accelerated and rugged usage, such as forceful attempts to turn the motor in the opposite direction of its movement. This could potentially damage the gears of the motor 102 which may be prevented by the robot companion device 100.

In an exemplary embodiment, the robot companion device 100 detects motor usage patterns and motor behaviour and the robot companion device 100 measures the velocity of the motors using the one or more encoders 104A-N. The measured velocity of the motors is further utilized to predict motor usage patterns and motor behaviour.

In another embodiment, the threshold motor speed is dynamically set for prediction of the abnormal state of the motor 102 based on the motor velocities. The dynamic threshold value is scaled according to a scaling algorithm and the scaling algorithm considers various parameters like but not limited to variation in motors, assemblies, change of surface.

In another embodiment, when the measured motor velocity falls below the computed the dynamic threshold motor speed, the robot companion device 100 predicts the occurrence of an abnormal state and forces the motor 102 of the robot companion device 100 to an off state.

In another embodiment, the motor velocities/speed are mapped at different defined voltages and these motor speeds are considered for expected operating conditions. Further, the motor speed computation for voltages other than the defined voltages are carried out by performing linear interpolation of the motor velocities computed for the defined voltages to determine behaviour of the motor 102 at different surfaces.

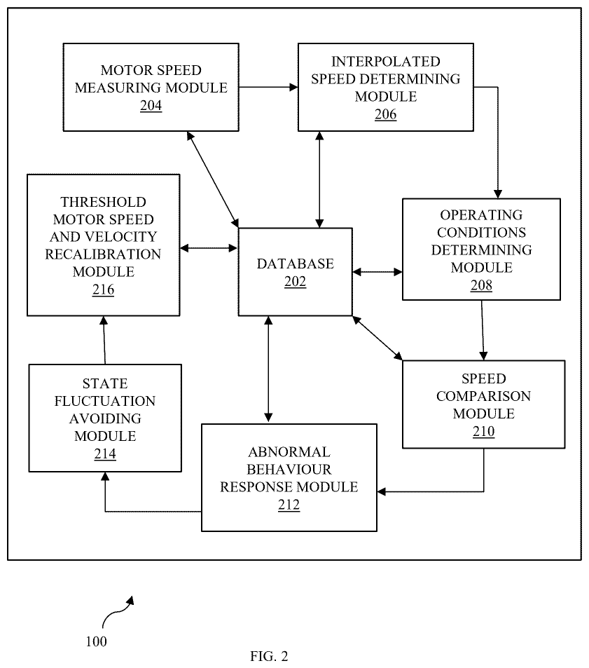

FIG. 2 illustrates an exploded view of the robot companion device 100 of FIG. 1 according to some embodiments herein. The robot companion device 100 includes a database 202, a motor speed measuring module 204, an interpolated speed determining module 206, an operating condition determining module 208, a speed comparing module 210, an abnormal behaviour response module 212, a state fluctuation avoiding module 214, a threshold motor speed and velocity recalibration module 216. The motor speed measuring module 204 measures the speed and the velocity of the motor 102 in real-time when the robot companion device 100 is operated on a plurality of surfaces. The one or more encoders 104A-N are attached to a motor 102 of the robot companion device 100 to measure the motor speed. The interpolated speed determining module 206 maps the motor speed with different defined voltages that is supplied to the robot companion device 100 to generate (i) an interpolated speed for intermediate voltages.

The operating condition determining module 208 maps the motor speed with different defined voltages that is supplied to the robot companion device 100 to generate one or more operating conditions of the robot companion device 100 in one or more surfaces. The speed comparing module 210 detects motor behaviour state by dynamically comparing measured speeds and velocities of the motor with a threshold motor speed and velocity using a detection algorithm. The abnormal behaviour response module 212 determining the motor behaviour as an abnormal behaviour state and automatically trigger a stop condition of the motor when the measured speed and velocity of the motor falls below the threshold motor speed and velocity.

The state fluctuation avoiding module 214 employs a debouncing technique that increases the threshold motor speed and velocity of the motor in case of an abnormal condition of the robot companion device 100 to avoid state fluctuations and to confirm the abnormal state of the robot companion device 100 based on the confirmation time period/duration of the abnormal condition (e.g. 1 to 5 milliseconds). The threshold motor speed and velocity recalibration module 216 employs a machine learning model 110 to recalibrate the threshold motor speed based on the motor usage and aging by monitoring the motor speed and the motor usage of the mobile companion device 102 to update the threshold motor speed.

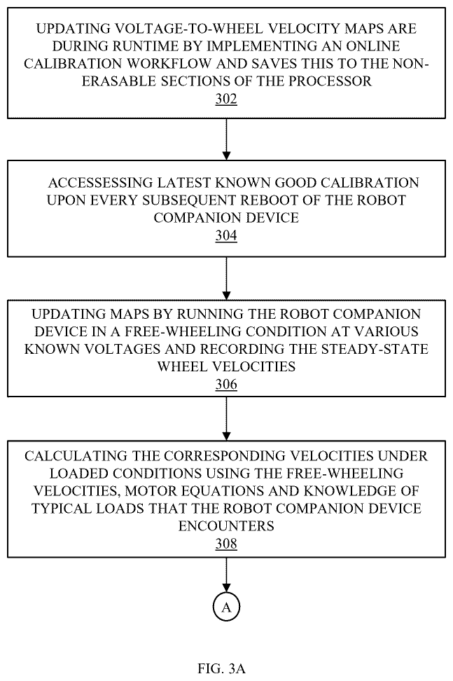

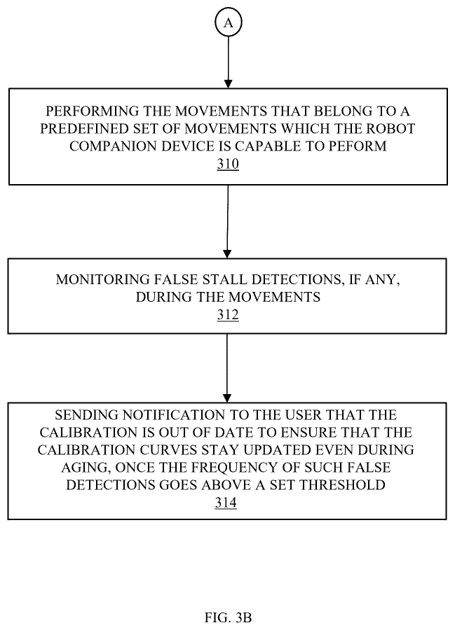

FIGS. 3A-3B illustrates recalibration of robot companion device in case of two events that is End-of-line calibration and Aging calibration according to some embodiments herein. The correlation between the wheel velocities and the voltage applied is the cornerstone of the detection algorithm. Any change in the motor characteristics that affect this correlation will adversely affect the sensitivity and specificity of the detection.

FIG. 3A illustrates End-of-line calibration which includes (i) updating voltage-to-wheel velocity maps during runtime by implementing an online calibration workflow and saving these to the non-erasable sections of the controller, (ii) accessing latest known good calibration upon every subsequent reboot of the robot companion device, (iii) updating the maps by running the robot companion device in a free-wheeling condition at various known voltages and recording the steady-state wheel velocities, (iv) calculating the corresponding velocities under loaded conditions using the free-wheeling velocities, motor equations and knowledge of typical loads that the robot companion device encounters.

FIG. 3B illustrates Aging calibration which includes (i) performing the movements that belong to a predefined set of movements which the robot companion device 100 is capable to perform, (ii) monitoring false stall detections, if any, during these movements, and (iii) sending notification to the user that the calibration is out of date to ensure that the calibration curves stays updated even during aging, once the frequency of such false detections goes above a set threshold. The robot companion device 100 includes an additional decision layer to trigger such a calibration for aging motors.

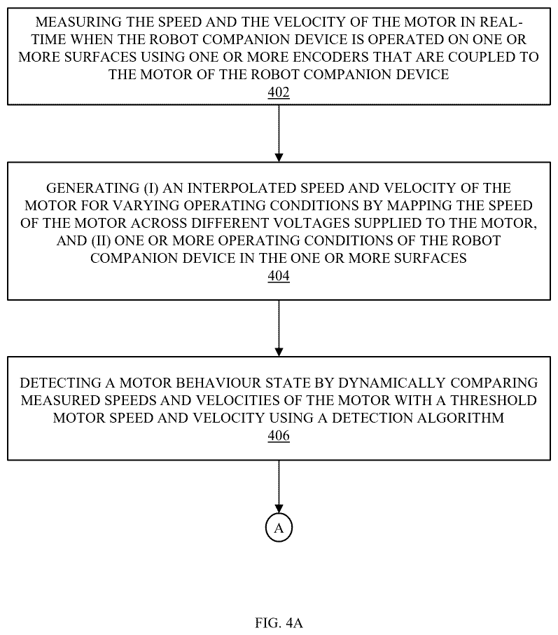

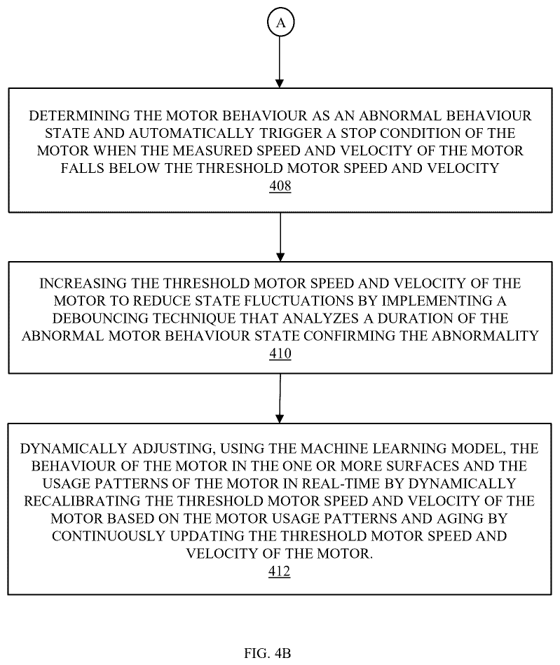

FIGS. 4A-4B illustrates a method for dynamically adjusting a behaviour of a motor across different surfaces and usage patterns of the motor in a robot companion device according to some embodiments herein. At step 402, the method includes measuring the speed and the velocity of the motor 102 in real-time when the robot companion device 100 is operated on one or more surfaces using one or more encoders 104A-N that are coupled to the motor of the robot companion device 100. at step 404, the method includes generating (i) an interpolated speed and velocity of the motor 102 for varying operating conditions by mapping the speed of the motor 102 across different voltages supplied to the motor 102, and (ii) one or more operating conditions of the robot companion device 100 in the one or more surfaces. At step 406, the method includes detecting a motor behaviour state by dynamically comparing measured speeds and velocities of the motor 102 with a threshold motor speed and velocity using a detection algorithm. At a step 408, the method includes determining the motor 102 behaviour as an abnormal behaviour state and automatically trigger a stop condition of the motor when the measured speed and velocity of the motor 102 falls below the threshold motor speed and velocity. At step 410, the method includes increasing the threshold motor speed and velocity of the motor 102 to reduce state fluctuations by implementing a debouncing technique that analyzes a duration of the abnormal motor behaviour state confirming the abnormality. At a step 412, the method includes dynamically adjusting, using the machine learning model 110, the behaviour of the motor in the one or more surfaces and the usage patterns of the motor in real-time by dynamically recalibrating the threshold motor speed and velocity of the motor 102 based on the motor usage patterns and aging by continuously updating the threshold motor speed and velocity of the motor 102.

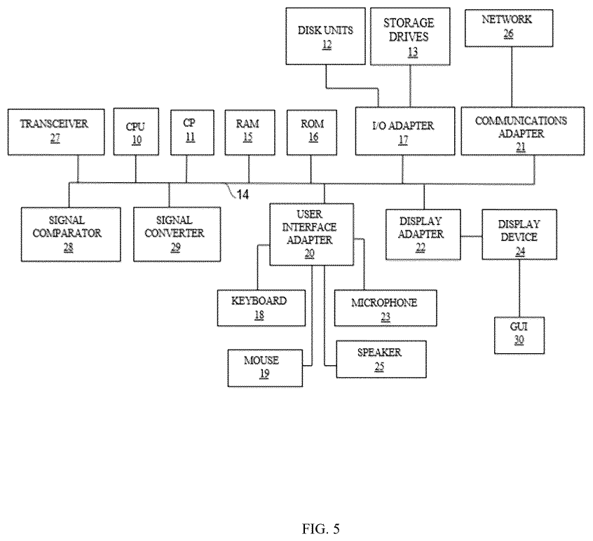

A representative hardware environment for practicing the embodiments herein is depicted in FIG. 5, with reference to FIG. 1 to FIG. 4B. This schematic drawing illustrates a hardware configuration of a system 100/a server/computer system/computing device in accordance with the embodiments herein. The system 100 includes at least one processing device CPU 10 that may be interconnected via system bus 14 to various devices such as a random access memory (RAM) 12, read-only memory (ROM) 16, and an input/output (I/O) adapter 18. The I/O adapter 18 can connect to peripheral devices, such as disk units 38 and program storage devices 40 that are readable by the system. The system can read the inventive instructions on the program storage devices 40 and follow these instructions to execute the methodology of the embodiments herein. The system further includes a subject interface adapter 22 that connects a keyboard 28, mouse 30, speaker 32, microphone 34, and/or other subject interface devices such as a touch screen device (not shown) to the bus 14 to gather subject input. Additionally, a communication adapter 20 connects the bus 14 to a data processing network 42, and a display adapter 24 connects the bus 14 to a display device 26, which provides a graphical subject interface (GUI) 36 of the output data in accordance with the embodiments herein, or which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope.

I/We claim:

1. A robot companion device that dynamically adjusts a behaviour of a motor across different surfaces and usage patterns of the motor, wherein the robot companion device comprises:
the motor;
one or more encoders that are coupled to the motor of the robot companion device, wherein the one or more encoders are configured to measure the speed and the velocity of the motor in real-time when the robot companion device is operated on a plurality of surfaces;
a memory that stores one or more instructions; and
a processor that executes the one or more instructions, wherein the processor is configured to:
generate (i) an interpolated speed and velocity of the motor for varying operating conditions by mapping the speed of the motor across different voltages supplied to the motor, and (ii) a plurality of operating conditions of the robot companion device in the plurality of surfaces;
detect a motor behaviour state by dynamically comparing measured speeds and velocities of the motor with a threshold motor speed and velocity using a detection algorithm;
determine the motor behaviour as an abnormal behaviour state and automatically trigger a stop condition of the motor when the measured speed and velocity of the motor falls below the threshold motor speed and velocity;
increase the threshold motor speed and velocity of the motor to reduce state fluctuations by implementing a debouncing technique that analyzes a duration of the abnormal motor behaviour state confirming the abnormality; and
dynamically adjust, using a machine learning model, the behaviour of the motor in the plurality of surfaces and the usage patterns of the motor in real-time by dynamically recalibrating the threshold motor speed and velocity of the motor based on the motor usage patterns and aging by continuously updating the threshold motor speed and velocity of the motor.

2. The robot companion device as claimed in claim 1, wherein the machine learning model determines normal behaviour and triggers a continuation condition of the motor when the measured speed and velocity of the motor is above the threshold motor speed and velocity.

3. The robot companion device as claimed in claim 1, wherein the machine learning model is trained to determine a threshold motor speed and velocity of the motor at different stages of the motor behaviour state and dynamically adjusts the threshold motor speed and velocity of the motor on different surfaces and usage patterns.

4. The robot companion device as claimed in claim 1, wherein the threshold motor speed and velocity of the robot companion device is a predefined speed limit that serves as a benchmark for normal operation of the robot companion device's motor.

5. The robot companion device as claimed in claim 1, wherein the processor is configured to divide the operating voltage range supplied to the robot companion device into equally spaced defined voltages.

6. The robot companion device as claimed in claim 3, wherein the processor is configured to run the motor at the specific defined voltages to measure the motor speed of the robot companion device when freewheeling to obtain a freewheeling speed.

7. The robot companion device as claimed in claim 1, wherein the threshold motor speed, below which the motor velocity is deemed abnormal, is determined by multiplying the freewheeling motor speed by a minimum percentage value, wherein the percentage value is established after running numerous test cases to find a value that minimizes false positives while effectively and quickly detecting abnormal conditions.

8. The robot companion device as claimed in claim 1, wherein the processor is configured to determine the confirmation time period by running experiment with different time values and identifying a value that has minimum false stall.

9. The robot companion device as claimed in claim 1, wherein the processor is configured to enable a normal operating condition to revert if the motor speed of the robot companion device exceeds the increased threshold motor speed with the confirmation time period to avoid false positives.

10. The robot companion device as claimed in claim 1, wherein the processor is configured to update the threshold motor speed during runtime by implementing an online calibration workflow that updates a voltage-to-motor velocity map during free-wheeling conditions of the robot companion device and storing the updated voltage-to-motor velocity map in non-erasable memory.

11. The robot companion device as claimed in claim 8, wherein the processor is configured to trigger recalibration of the threshold motor speed for aging motors of the robot companion device based on a frequency of false stall detections during a predefined movement and notify a user when the calibration is out of date to ensure current calibration curves stay updated even during aging.

12. A method to dynamically adjust a behaviour of a motor across different surfaces and usage patterns of the motor in a robot companion device, wherein the method comprises:
measuring the speed and the velocity of the motor in real-time when the robot companion device (100) is operated on a plurality of surfaces using one or more encoders that are coupled to the motor of the robot companion device;
generating (i) an interpolated speed and velocity of the motor for varying operating conditions by mapping the speed of the motor across different voltages supplied to the motor, and (ii) a plurality of operating conditions of the robot companion device in the plurality of surfaces;
detecting a motor behaviour state by dynamically comparing measured speeds and velocities of the motor with a threshold motor speed and velocity using a detection algorithm;
determining the motor behaviour as an abnormal behaviour state and automatically trigger a stop condition of the motor when the measured speed and velocity of the motor falls below the threshold motor speed and velocity;
increasing the threshold motor speed and velocity of the motor to reduce state fluctuations by implementing a debouncing technique that analyzes a duration of the abnormal motor behaviour state confirming the abnormality; and
dynamically adjusting, using the machine learning model, the behaviour of the motor in the plurality of surfaces and the usage patterns of the motor in real-time by dynamically recalibrating the threshold motor speed and velocity of the motor based on the motor usage patterns and aging by continuously updating the threshold motor speed and velocity of the motor.
